(19) United States
(12) Patent Application Publication
(10) Pub. No.: US 2026/0076362 A1
(43) Pub. Date: Mar. 19, 2026

(54) A COLD PROCESSING DEVICE

(71) Applicant: SÜLEYMAN DEMIREL ÜNIVERSITESI IDARI VE MALI ISLER DAIRE BASKANLIGI GENEL SEKRETERLIK, ISPARTA (TR)

(72) Inventors: Halil ASCI, ISPARTA (TR); Selçuk ÇÖMLEKÇI, ISPARTA (TR); Mehtap SAVRAN, ISPARTA (TR); Rümeysa TANER, ISPARTA (TR)

(21) Appl. No.: 19/106,228

(22) PCT Filed: Dec. 29, 2022
(86) PCT No.: PCT/TR2022/051690

§ 371 Date: Feb. 25, 2025

(30) Foreign Application Priority Data
Aug. 31, 2022 (TR) 2022/013586

(51) Int. Cl. A01N 1/148; G01N 1/28

(52) U.S. Cl. CPC A01N 1/148; G01N 1/286; G01N 2001/2873

(57) ABSTRACT

Disclosed herein is a cold processing device which is developed for the portioning and storage of the tissues of treated animal during animal experiments and for the non-mixing and transportation of the tissues, and for the transportation and protection of blood and similar liquid materials taken from the animal, for helping to ensure standardization in experiments. The disclosure also relates to the prevention of a trauma that may occur on the tissue during transportation or external factors that may change the analysis to be made, with the help of the equal cold effect on every part of the tissue taken from the animal since the inventive cold processing device is for animal experiments in preclinical studies and, is a cold storage and transport system.

This application is a National Phase entry of International Application No. PCT/TR2022/051690 under § 371 and claims the benefit of Turkish Patent Application No. TR2022/013586, filed Aug. 31, 2022, which is hereby incorporated by reference in its entirety.

### FIELD OF THE DISCLOSURE

The present disclosure relates to a cold processing device which is developed for the portioning and storage of the tissues of the treated animal during animal experiments and for the non-mixing and transportation of the tissues, and for the transportation and protection of blood and similar liquid materials taken from the animal, for helping to ensure standardization in experiments.

The present disclosure also relates to the prevention of a trauma that may occur on the tissue during transportation or external factors that may change the analysis to be made, with the help of the equal cold effect on every part of the tissue taken from the animal since the inventive cold processing device is for animal experiments in preclinical studies and is a cold storage and transport system.

### BACKGROUND

Today, it is known that preclinical studies, which must be carried out before the application of active substances and medical devices to humans, are continuing rapidly all over the world. It is crucial that all kinds of new active substances and medical devices discovered in the field of health sciences pass through the preclinical phase before they are applicable to humans. Animal experiments applied within this scope include very difficult procedures from planning and finalizing. It is very crucial that each of the tissues taken is treated equally and stored under equal conditions in these experiments, which are carried out by experienced teams and using effective/quality products. The tissues must be put in the refrigerator and kept in a cold area during and after the portioning process of each tissue which is prepared for the unit where it will be analyzed. It is crucial that these obligatory applications are carried out in certain standardization. Tissues taken from experimental animals should be portioned in a suitable cold environment without losing their freshness. Portioned animal tissues must be stored and quickly delivered to the units where they will be analyzed. Traditional methods used for this may affect the results of the analysis to be made and may cause the researcher's effort to be wasted. The cold environment requirement for all processes of these processes has become obligatory for the proper transmission of the tissue.

Today, heat conduction is the transfer of heat from a hot region to a colder region in a solid material or stagnant fluid. In case there are temperature differences in a solid body, heat passes from the high temperature zone to the low temperature zone by conduction. The heat transmission coefficient is a factor that shows how well or how fast a material conducts heat (unit value is given as heat transfer coefficient W/m·K.). Heat conduction is a distinctive feature for substances. The heat conduction law explains the relationship between the amount of heat energy transferred and the type of substance with the ratio of the heat transmission coefficient. The heat transfer coefficient is the power value required to increase the temperature of a point one meter away from a substance by 1 Kelvin. The heat transmission coefficient differs according to the product from which the material is produced. Heat conduction is a distinctive feature particularly for solid substances. For example, while the thermal conductivity coefficient of styrofoam polystyrene, that is, insulation foam material, is 0.039 W/m·K (TS EN 13163), heat transfer coefficient of poly lactic acid (PLA) is 0.13 W/m·K. These values determine the isolation value.

In the state of the art, the aluminum foil wrapped around the battery, which they use as a bench to cut the tissues taken from the animal, is torn at each scalpel stroke during the process. The foil edges also damage the tissue during this tissue cutting process on aluminum foil. However, each time a new tissue arrives, the battery must be wrapped with foil again so as to prevent any contamination and not affect the analysis results. The aluminum foil wrapped around the battery partially provides the cold environment, cannot provide the required flat surface and is constantly damaged during the operation with the scalpel tip. There is also a prolongation of the test times due to this process. Therefore, this method used in the state of the art is disadvantageous.

In the state of the art, it is necessary to have a standard system that provides the same degree of cold exposure in all directions for the refrigerated storage of the portioned tissues taken from the animal. In cases where the tissue is not exposed to the same degree of cold in all directions, the quality of the tissue is affected. However, there is no such a system used in the state of the art. A lot of ice or batteries are placed in the foam container used for the tissues that need to be transmitted to the analysis units. However, these materials are not always available. In addition to this, these materials do not last long enough for long-term transportation. Besides all these, it is insufficient as the cold cannot be provided to all parts of the tissue equally.

A slicing device for laboratory biological research is disclosed in the document numbered CN113776908A in the state of the art. It is a tissue/paraffin tissue slicing device used especially for laboratory biological research. It prevents any contamination and damage to the tissue sample. In addition to this, it is a device maintained so as to prevent the tissue sample from being affected by temperature. It is effective due to the short distance between it and the tissue sample by conveying cold air from a cold air hole. The diffusion range is small and the contact distance with the tissue sample is close, which causes the tissue sample to be constantly exposed to cold. In addition, it comprises a method developed for cutting the portioned and paraffinized samples into thin slices. The device is fixed laboratory equipment and does not include a method for transporting, storing and keeping samples. On the contrary, there must be a device which is developed for preserving the structure of the tissue slice, which prevents the curling of the slices by means of the cold air and prevents the paraffin of the cut slices from melting, while taking thin slices from the paraffinized tissue after portioning. Said device does not have elements such as exposure to cold during tissue portioning, transportation/storage of tissue and the like.

The document numbered U.S. Pat. No. 4,615,183A, known in the state of the art, relates to a cold plate for laboratory use, particularly useful for tissue micro and macro dissection procedures. Said invention provides improved dissection of frozen tissues, provides tissue micro and macro dissection such as brain tissue dissection, provides a dissection that will cool homogeneously. It is combined with a remotely operated cooling unit so as to cool said cold plate to any desired cold temperature. In addition to this, it is a cold plate with a protective holding slot. It has the property of not melting a sample placed thereon early. Besides, the structure is made of a thermally conductive material in a rectangular configuration such as iron or copper. The device is fixed laboratory equipment and does not include a method for transporting, storing and keeping samples. Said device does not have elements such as exposure to cold during tissue portioning, transportation/storage of tissue and the like.

Since there are no standard storage containers in the prior art, an eppendorf tube is a material used for tissues. Eppendorf tube has a narrow area in structure. Therefore, placing the tissue in an area where it will be compressed may also cause damage to the tissue or adversely affect the analysis results.

In the state of the art, blood, serum and similar biological materials must be transported. The surroundings of the spore equipment in which blood and serum are placed are open and open to being exposed to the external environment. Cold chain is often required for the transportation of these products. All samples are not exposed to the same cold, and problems may occur during transportation in the cold chains where these small-sized samples are transported.

There are plastic separators in the prior art used for storing or separating or transporting tissues after portioning. Although these separators do not have a cooler, portioned tissues are again wrapped in a product (aluminum foil, etc.) and taken to the refrigerator after they are placed in separator boxes, or transported by placing the same in a foam box with dry ice. Said plastic separator which is used only to separate the tissues from each other and to cut off their contact with the surfaces, has disadvantages such as not comprising any cooling system and giving damage to the tissue as the box areas are narrow for some tissue portions.

As can be seen in the methods used in the state of the art, there is no complete system apart from the absence of standard storage containers except organ transplant containers used in human-to-human organ transplantation. Disadvantages and product deficiencies in the state of the art make it necessary to make an R&D study in this field.

### SUMMARY

One of the main aims of embodiments of the present invention is to provide cold tissue cutting bench, refrigerated tissue storage container and cooled spore structures for the transport of blood and similar liquids so as to prevent disruptions that may occur during transport and external factors that change the analysis by allowing the cutting of small-sized tissues taken from animals, and also providing a standardized storage condition since it will be a tissue storage container.

One of the main aims of embodiments of the present invention is to provide a continuous and even cooling effect with the help of a base and a cooling material division positioned in the base and to prevent the tissues to be used for analysis from being damaged by the temperature difference by placing a tissue cutting machine on the base, where the portioning of the tissues taken is carried out or by placing spores containing slots in which biochemistry tubes will be placed, or by placing a cover containing divisions that allow tissues to be transported.

An aim of embodiments of the present invention is to provide equal exposure to cold effect to every area of the sampled animal tissue used for the experiment and thus to prevent trauma on the tissue during transportation.

Another aim of embodiments of the present invention is to use the same not only for experimental animals, but also for portioning pathological preparations and similar experimental animal applications, with a structure that allows cutting, storing and transporting small-sized tissues.

Another aim of embodiments of the present invention is to use the same for the transportation of small-sized tissues after portioning, while simultaneously to provide transportation even between cities with dry ice supplement.

An aim of embodiments of the invention is to ensure that blood, serum and similar biological materials can be subjected to long-term transport processes within a cold environment.

Another aim of embodiments of the present invention is to keep the taken tissues at a volumetric homogeneous temperature during transportation and processing, to distribute the temperature equally to all parts of the tissue and to ensure that every point of the tissue is protected at the same temperature.

Another aim of embodiments of the present invention is to prevent the tissue from being exposed to excessive cold by preventing overflow and leakage by closing the structure containing the divisions where the cooling material placed in the base will travel with a sealing gasket after putting the cooling material through the hole in the center area.

An aim of embodiments of the present invention is to transport both tissue and biochemistry samples at the same time as well as to protect tissue or blood or serum samples taken from animals during the cutting of the tissue by being equally exposed to a constant cold from all directions without being affected by the temperature difference.

Another aim of embodiments of the present invention is to ensure that the system can be easily stored by placing the same in a transport cabinet, together with the base, for the transportation of tissue sample or blood or serum samples and to allow the preservation of the required temperature in long-term storage of tissues.

Another aim of embodiments of the present invention is to ensure that tissue, blood or serum samples are transported without any damage over distances of 3 hours only with the transport container with the help of the extra protection and insulation of the same with the transport container, and at distances of 5 hours and more with the support of dry ice.

### BRIEF DESCRIPTION OF THE FIGURES

A brief description of figures representing embodiments of the cold processing device is provided below.

FIG. 1 is ta perspective view of an interior division of a cold processing device, according to at least one embodiment.

FIG. 2 is a rear view of the interior division and cooler walls of a cold processing device, according to at least one embodiment.

FIG. 3 is a joint view of a cooler case and interior division of a cold processing device, according to at least one embodiment.

FIG. 4 is a joint view of a cooler case and cutting bench of a cold processing device, according to at least one embodiment.

FIG. 5 is a joint view of a spore body and the cooler case of a cold processing device, according to at least one embodiment.

FIG. 6 is a front side perspective view of a spore body of a cold processing device, according to at least one embodiment.

FIG. 7 is a joint view of a tissue handling unit and cooler case of a cold processing device, according to at least one embodiment.

FIG. 8 is a general perspective view of a transport cabin of a cold processing device, according to at least one embodiment.

### DETAILED DESCRIPTION

A list of reference numbers follows.
1. Tissue Cutting Bench
1.1 Waste Division
1.2. Cutting Surface
1.3. Protrusion
1.4. Cooler Surface
2. Cooler Case
2.1. Channel
2.2. Exterior wall
2.3. Interior Wall
3. Interior Division
3.1. Lock Housing
3.2. Upper Housing
3.3. Cooler Wall
3.4. Lower Housing
4. Spore Body
4.1. Spore Housing
4.2. Spore Division
5. Transport Cabin
5.1. Handle
5.2. Slot
6 Tissue Handling Unit
6.1. Tissue Divisions

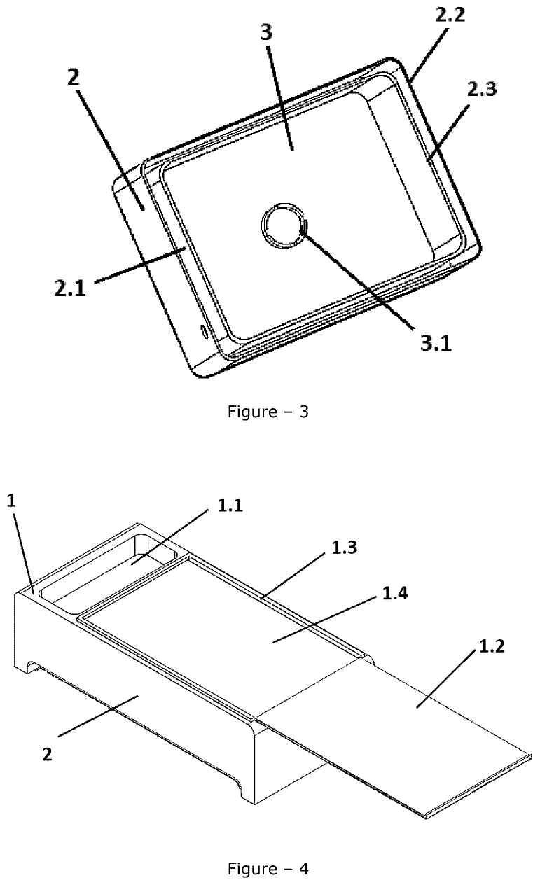

A cold processing device which is the subject of embodiments of the invention comprises of a cooler case (2), detailed in FIG. 3, in which the cooling material and covers are accommodated, an interior division (3) located inside the cooler case (2), which allows the processes to be carried out in a cold environment or to be protected or transported during the test. There are a total of three parts positioned on the cooler case (2). These are as follows; a tissue cutting bench (1) for the cutting process taken from experimental animals, a spore body (4) in which blood, serum and similar materials taken from experimental animals are placed, and a tissue handling unit (6) that allows the tissues taken to be separated and transported after portioning.

The cooler case (2) comprises an interior wall (2.3) and an exterior wall (2.2). There is a channel (2.1) between the interior wall (2.3) and the exterior wall (2.2). The thicknesses of the exterior wall (2.2) and the interior wall (2.3) are adjusted as 3 mm. The interior wall (2.3) and the exterior wall (2.2) provide external insulation with the help of the cooling material added to the channel (2.1) of the cooler case (2). Thus, it is ensured that the cold is transmitted equally to all parts of the equipment such as the spore body (4), the tissue cutting bench (1) and the tissue handling unit (6), which are positioned on the cooler case (2). The cooler case (2) is made of poly lactic acid (PLA) material. The thermal conductivity coefficient of the PLA material used is 0.13 W/m·K, thus making it a suitable material for insulation. The thickness of the exterior wall (2.2) and the interior wall (2.3) made of the PLA material used is 3 mm.

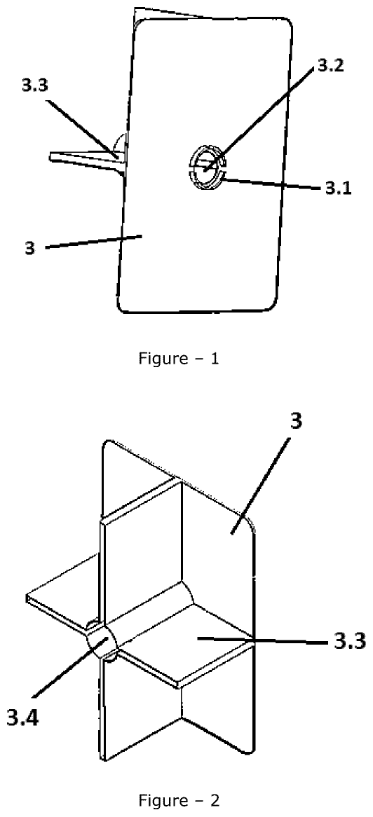

The interior division (3), the detail of which is shown in FIG. 1 comprises a lock housing (3.1) in which the sealing gasket is located, an upper housing (3.2) that allows the cooling material to be added from the top, a lower housing (3.4) that allows the cooling material to spread out from the lower surface, cooler walls (3.3) that allow the cooling material coming out of the lower housing (3.4) to spread evenly to the inner body of the cooler case (2). The interior division (3) is made of poly lactic acid (PLA) material. The thermal conductivity coefficient of the PLA material used is 0.13 W/m·K, thus making it a suitable material for insulation. The samples placed on the apparatus such as the spore body (4), the tissue cutting bench (1) and the tissue handling unit (6) placed on the cooler case (2) are equally exposed to the cold from all directions with the help of the interior division (3). Cooling material is filled into the cooler walls (3.3). Thus, the cooling material coming out of the lower housing (3.4) is spread along the cooler walls (3.3) and every area is exposed to cold equally. (FIG. 2)

The interior division (3) positioned in the cooler case (2) ensures that the cooling material is distributed evenly in the middle area of the case. After the interior division (3) is positioned inside the cooler case (2), the cooling material is added from the upper housing (3.2) of the interior division (3). The added cooling material reaches the lower housing (3.4) of the interior division (3) and spreads to the cooler walls (3.3). Overflow or spillage of the cooling material is prevented by adding a sealing gasket to the lock housing (3.1) of the interior division (3) upper housing (3.2), after the cooling case (2) and the interior division (3) are positioned together and the cooling material is added. The cooler case (2) is placed in the refrigerator to further increase the desired cold effect after the cooling material is added.

A tissue cutting bench (1), detailed in FIG. 4, is used to cut and portion the tissues taken from the experimental animal after the cooler case (2) is prepared for processing. The tissue cutting bench (1) comprises a cooler surface (1.4) in contact with the interior division (3), a protrusion (1.3) on the edge such that the tissues do not mix with each other, a cutting surface (1.2) which is positioned on the cooler surface (1.4) and enables tissue cutting and portioning on a cold surface and a waste division (1.1) that separates the cut tissues such that they do not mix with each other. The tissue cutting bench (1) is made of poly lactic acid (PLA) material. The thermal conductivity coefficient of the PLA material used is 0.13 W/m·K, thus making it a suitable material for insulation.

The tissue cutting bench (1) is positioned on the cooler case (2), which has been made ready by positioning the interior division (3), to which the cooling material has been added. Subsequently, a cutting surface (1.2) is positioned on the cooler surface (1.4) and the cutting process is performed. Therefore, the cooler surface (1.4), which is in contact with the interior division (3) during the cutting and portioning of the tissues, ensures that the tissues in the process performed on the cutting surface (1.2) are equally exposed to the cold. The cutting surface (1.2) is scratch-proof (it is made of non-scratchable material), and the heat transmission coefficient is 0.13 W/m·K. In addition, the scratch-proof cutting surface (1.2) is hygienically reusable. After the portioned tissues are placed in the waste division (1.1), the process continues. The waste division (1.1) is 13 mm deep and serves as a waiting area for tissues. The protrusion (1.3) on the cooler surface (1.4) edges prevents the tissues from mixing. A tissue cutting bench (1) with cooler is obtained with all these components.

Since all tissues portioned during the process will be exposed to cold equally, they are not exposed to any deterioration during the process and the experiment. All materials constituting the assembly are made of poly lactic acid (PLA) material. The thermal conductivity coefficient of the PLA material used is 0.13 W/m·K, thus making it a suitable material for insulation. Distilled water or cooling material to be circulated on the cooler walls (3.3) according to the sensitivity of the tissues is added from the upper housing (3.2) of the system, it spreads to the cooler walls (3.3) passing through its lower housing (3.4). Therefore, it is ensured that the portioned tissues for analysis are kept at a homogeneous temperature value, a proper portioning is provided without being affected by external effects due to temperature difference or surface difference. Thus, it is prevented from affecting the analysis results. The cold affects every part of the tissue equally with the help of the cooler case (2). Although the cutting surface (1.2) is not scratched, it is manufactured in such a way that adhesion to the surface or adhesion of tissue parts to each other is minimized.

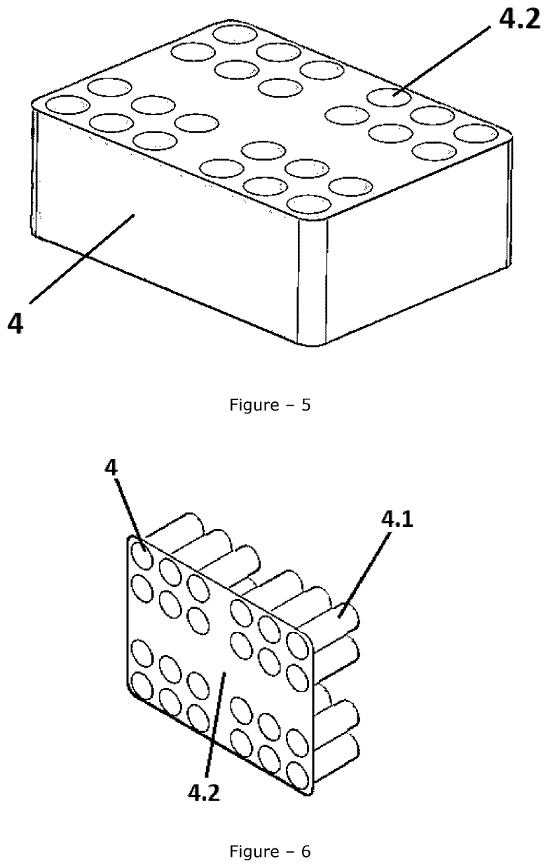

Likewise, blood, serum and similar materials are taken from experimental animals for analysis. A spore body (4), the detail of which can be seen in FIG. 6 is positioned on the cooler case (2), which has been made ready by positioning the interior division (3), to which the cooling material has been added. There are spore divisions (4.2) located on the spore body (4). After the blood or serum or other fluid samples taken from the animal are taken into biochemistry tubes, they are placed in the spore housings (4.1) of the spore divisions (4.2). The lower surfaces of the spore housings (4.1) are in contact with the interior division (3), it is ensured that the samples positioned in the spore housings (4.1) with biochemistry tubes are exposed to a cold environment with the help of both the cooling material circulating in the cooler case (2) channel (2.1) and the cooling material circulating on the cooler walls (3.3) and the base of the interior division (3). Thus, while the skilled person is taking or preparing other samples, the other samples are not exposed to any temperature-related deterioration during the experiment. That is to say, even if the samples are not processed or stored immediately, they remain cold throughout the experiment with the help of the cooler case (2). Similar to the other covers, the spore body (4) is also made of PLA material. The thermal conductivity coefficient of the material is 0.13 W/m·K, thus making it a suitable material for insulation. (FIG. 5) The spore body (4) used ensures that the samples taken from 6 experimental animals are divided into 4 different areas and used in different sections. The thickness of the walls is 3 mm in the structure made of PLA material. The spore body (4) consists of a total of 24 equal divisions. The value of each compartment is ø 20 mm and their depth is 55 mm. The system is reusable by using distilled water and similar cooling materials around the spore housings (4.1) where blood tubes are placed. Also, the body (4) ensures that the blood tubes named during the experiment are stored systematically without loss of time and confusion.

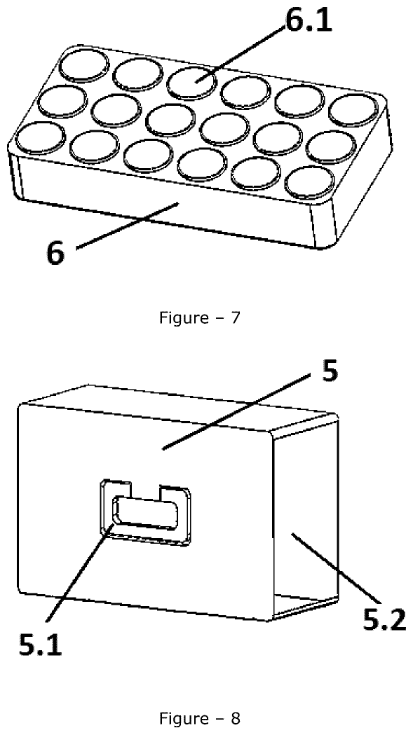

The cooler case (2) and the interior division (3) are positioned similarly before the tissue handling unit (6) detailed in FIG. 7 is positioned on the cooler case (2) and then the cooling material is added to make it ready for processing. Subsequently, a tissue handling unit (6) with tissue divisions (6.1) thereon positioned on the cooler case (2). The tissue handling unit (6) is capable of both separating the tissues for different analysis processes and allowing them to be transported or stored for a certain period of time. Portioned tissues are separated by placing them in tissue divisions (6.1) on the tissue handling unit (6). The tissues are modeled as a system where 6 different tissues of 3 different animals can be taken. The tissue divisions (6.1) have a depth of 55 mm. It is made of PLA material, the thermal conductivity coefficient of the material is 0.13 W/m·K, thus making it a suitable material for insulation. The thickness of the walls is 3 mm in the structure made of PLA material.

After the tissue handling unit (6) is positioned on the cooler case (2) and the tissues are placed in the tissue divisions (6.1), it is positioned in the slot (5.2) of a transport cabin (5). The tissue handling unit (6) provides the storage of portioned tissues for different analysis processes. It is ensured that the user does not come into contact with the cooler case (2) with the help of the handle (5.1) on the transport cabin (5). Thus, the samples are not exposed to the body heat of the user as an external factor. In addition, there is no discomfort or burning in the user's hand since the user will not be in direct contact with the dry ice-containing environment during transportation,

As in the tissue handling unit (6), the samples added to the spore body (4) used are also transported with the transport cabin (5), the details of which are shown in FIG. 8. After the biochemistry tubes are positioned in the spore housings (4.1) of the spore body (4) on the cooler case (2) where the cooling material is added, the device is taken to the transport cabin (5) at the end of the process.

All kinds of samples are both easily storable and ensure the preservation of the required temperature for long-term storage of tissues or biochemistry samples during transportation with the help of the transport cabin (5). In addition, tissue samples on the tissue handling unit (6) located in the slot (5.2) of the transport cabin (5) and blood or serum samples in the spore slots (4.1) of the spore body (4) to be transferred to the relevant analysis unit without the need for an additional cooler can be transported for at least 3 hours without any thermal degradation. Furthermore, these devices, which are made of PLA material and have a thermal conductivity coefficient of 0.13 W/m·K, provide the opportunity to carry them to distances of 5 hours or more with the addition of dry ice. The heat dissipation at every point of the total volume does not make much difference than +/−10% with the dry ice supplement. For example; portions or biochemistry samples transported with a temperature of −20° C. lose a maximum of 2 degrees after 3 hours of transport and become −18° C. The whole structure of the spore body (4) has 3 mm walls.

Cooler case (2), inner compartment (3) tissue cutting bench (1), tissue transport unit (6) and spore body (4), and all other structures used in the cold processing assembly made of PLA material has sufficient mechanical strength and flexibility in the operating range of −80° C. and −20° C.

However, the heat dissipation in the entire volume is homogeneous. For example; the fresh tissue sample taken at 37° C. shows a maximum 10% temperature difference after 3 hours, regardless of which slot it is placed in the dry ice cooler case (2). That is to say, the temperature of the portion in the middle of the tissue handling unit (6) positioned on the cooler case (2) is measured as −16° C., while the internal temperature of the tissue in the farthest division is measured as −14.4° C.

The cold processing device described above is made of PLA material and the basic structure walls are 3 mm and in long-term transports of 5 hours or more, 3 cm thick styrofoam transport container is used.

1. A cold processing device comprising:
a cooler case comprising an exterior wall and an interior wall, the cooler case having a channel between the exterior wall and the inner wall and providing a cooling effect on both the exterior wall wall and the interior wall by adding cooling material to the channel,
an interior division which is positioned on an inner surface of the cooler case, from which the cooling material is added from an upper housing thereon, the interior division ensuring equal cooling of each region of the cooler case by spreading the cooling material from a lower housing to the cooler walls.

2. A cold processing device according to claim 1, further comprising a tissue cutting bench that is positioned on the cooler case, the tissue cutting bench enabling cutting and portioning of tissues taken from an experimental animal to be carried out thereon.

3. A cold processing device according to claim 2, further comprising a cutting surface positioned on a cooler surface that is in contact with the interior division, the cutting surface being integral with the tissue cutting bench, on which the tissue portioning is performed.

4. A cold processing device according to claim 3, further comprising a protrusion monolithic with the tissue cutting bench, the protrusion enabling the separation of portioned tissues on the cutting surface.

5. A cold processing device according to claim 3, further comprising a waste division that is used as a waiting area for the tissues portioned on the cutting surface, the waste division allowing the tissues that are portioned and separated during the tissue portioning to preserve their structure and freshness by exposure to cold.

6. A cold processing device according to claim 1, further comprising a spore body that is positioned on the cooler case, the spore body ensuring that (i) blood or serum and similar fluid samples taken from the experimental animal are placed in biochemistry tubes, (ii) the samples are kept cold and fresh, and are systematically stored.

7. A cold processing device according to claim 6, further comprising a spore housing that provides the exact positioning of the biochemistry tubes containing the samples to spore divisions on the spore body, the spore housing ensuring that the samples remain cold and fresh during the process by being in contact with the interior division.

8. A cold processing device according to claim 1, further comprising a tissue handling unit that is positioned on the cooler case, the tissue handling unit allowing the tissues to be separated from each other or transported, or allowing the portioned tissues to be stored for different analysis processes after being taken from the experimental animal, and placing the portioned tissues in A tissue division thereon.

9. A cold processing device according to claim 8, further comprising a transport cabin that is connected with the cooler case, the transport cabin providing transport, storage, or preservation of the samples after positioning the samples in the spore body or the tissue handling unit.

10. A cold processing device according to claim 9, further comprising a slot which provides positioning of the spore body or the tissue handling unit to the transport cabin.

11. A cold processing device according to claim 9, further comprising a handle which enables A user to carry the transport cabin after the cooler case containing the samples is positioned in the slot of the transport cabin.

12. A cold processing device according to claim 2, wherein the tissue cutting bench has a thermal conductivity of 0.13 W/m·K and is positioned on the cooler case, the tissue cutting bench ensuring that the portioned tissues are kept at a homogeneous temperature value, wherein the tissue cutting bench is made of Poly Lactic Acid (PLA) material with a wall thickness of 3 mm.

13. A cold processing device according to claim 5, wherein the waste division is positioned on the cooler case and has a depth of 13 mm.

14. A cold processing device according to claim 3, wherein the cutting surface is positioned on the cooler surface, is portable and provides hygienic use, and is made of an anti-scratch material with a heat conduction of 0.13 W/m·K.

15. A cold processing device according to claim 6, wherein the spore body where the blood or serum or similar fluid samples taken are positioned, has a thermal conductivity of 0.13 W/m·K and thus ensures that the samples are kept at a temperature value, wherein the spore body (i) is positioned on the cooler case, and (ii) is made of Poly Lactic Acid (PLA) material with a wall thickness of 3mm.

16. A cold processing device according to claim 7, wherein the spore divisions number at least 24 on the spore body.

17. A cold processing device according to claim 7, wherein a value of each of the spore housings forming the spore divisions on the spore body has a length of at least 20 mm and a depth of at least 55 mm.

18. A cold processing device according to claim 8, wherein the tissue handling unit has a thermal conductivity of 0.13 W/m·K and thus ensures that the samples taken are kept at a temperature value, wherein the tissue handling unit (i) is positioned on the cooler case, and (ii) is made of Poly Lactic Acid (PLA) material with a wall thickness of 3mm.

19. A cold processing device according to claim 8, wherein each of the tissue divisions located on the tissue handling unit where different animal tissues are stored, has a depth of 55 mm.

20. A cold processing device according to claim 1, wherein the cooler case, the tissue cutting bench, the spore body, the tissue handling unit, and said the transport cabin have sufficient mechanical strength and flexibility for temperatures in the range of −80° C. or −20° C. and are made of Poly Lactic Acid (PLA) material.

21. A cold processing device according to claim 1, wherein the thickness of an entirety of the cooler case, the exterior wall, and the interior wall is 3 mm.

22. A cold processing device according to claim 1, wherein the walls of an entirety of the inner division are 3 mm.

23. A cold processing device according to claim 1, further comprising a lock housing on which a sealed gasket is positioned to ensure that the cooling material remains in place after adding the cooling material from the upper housing of the interior division.
